(19) United States
(12) Patent Application Publication
(10) Pub. No.: US 2026/0011521 A1
(43) Pub. Date: Jan. 8, 2026

(54) Fuse Box

(71) Applicant: PACIFIC ENGINEERING CORPORATION, Gifu (JP)

(72) Inventors: Yosuke Kimura, Gifu (JP); Fumiyuki Kawase, Gifu (JP)

(73) Assignee: PACIFIC ENGINEERING CORPORATION, Gifu (JP)

(21) Appl. No.: 19/250,069

(22) Filed: Jun. 26, 2025

(30) Foreign Application Priority Data
Jul. 2, 2024 (JP) 2024-106916

(51) Int. Cl. H01H 85/20

(52) U.S. Cl. CPC H01H 85/2045

(57) ABSTRACT

Provided is a fuse box for mounting a fuse, the fuse box including: a connection portion connected to the fuse; and a side wall and a rear wall surrounding the connection portion, wherein an opening portion is disposed in front of the connection portion.

### BACKGROUND OF THE INVENTION

### (1) Field of the Invention

The present invention relates to a fuse box for mounting a fuse.

### (2) Description of Related Art

Conventionally, there are various types of fuses. For example, the fuse disclosed in Japanese Patent No. 7412035 includes an input terminal and an external terminal. The fuse is used by being mounted on a fuse box depending on the purpose. A fuse box for more stably mounting the fuse has been required.

### SUMMARY OF THE INVENTION

In view of the above problems, the present invention provides a fuse box to which a fuse can be stably mounted.

A fuse box according to the present invention is a fuse box for mounting a fuse, which includes a connection portion connected to the fuse; and a side wall and a rear wall surrounding the connection portion, wherein an opening portion is disposed in front of the connection portion.

According to the above feature, when the fuse is housed in the fuse box, the rear wall and the side wall of the fuse box guide the fuse so as to surround the periphery of the fuse, so that the fuse is easily mounted on the fuse box. Further, since the opening portion is disposed on the side in front of the connection portion for connecting the fuse to another connection terminal, the insertion state of the fuse can be visually observed.

In the fuse box according to the present invention, the connection portion includes a first connection portion and a second connection portion, and the second connection portion is disposed at a position higher than the first connection portion, and is coupled to the first connection portion by a wall portion rising upward from the first connection portion.

According to the above feature, the first connection portion, the wall portion, and the second connection portion of the fuse box are formed in a continuous step shape, and an inverted L-shaped fuse can be stably attached.

As described above, the fuse can be stably mounted according to the fuse box of the present invention.

### BRIEF DESCRIPTION OF THE DRAWINGS

FIG. 1A is an overall perspective view of a fuse box, and FIG. 1B is an overall perspective view of a state in which the fuse box is mounted on a power distribution box;

FIG. 2A is a front view of a state where a fuse box is mounted on a power distribution box, and FIG. 2B is a plan view of a state where the fuse box is mounted on the power distribution box;

FIG. 3A is a perspective view of a fuse, FIG. 3B is a side view of the fuse, and FIG. 3C is a front view of the fuse;

FIG. 4A is a perspective view of a state before the fuse is inserted into the fuse box, and FIG. 4B is a perspective view of a state where the fuse is mounted on the fuse box; and

FIG. 5A is a plan view of a state in which the fuse is mounted on the fuse box, and FIG. 5B is a cross-sectional view taken along line A-A.

### DETAILED DESCRIPTION OF PREFERRED EMBODIMENTS

Hereinafter, an embodiment of the present invention will be described with reference to the drawings. Shapes and materials of each member of the fuse box in the embodiment described below are merely examples, and are not limited thereto.

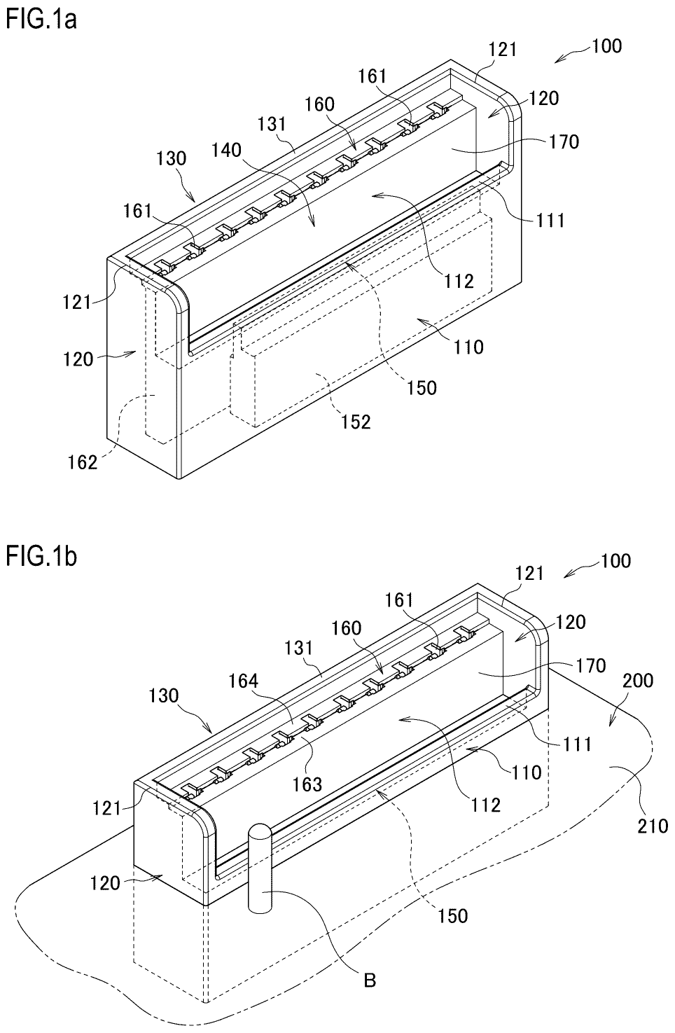

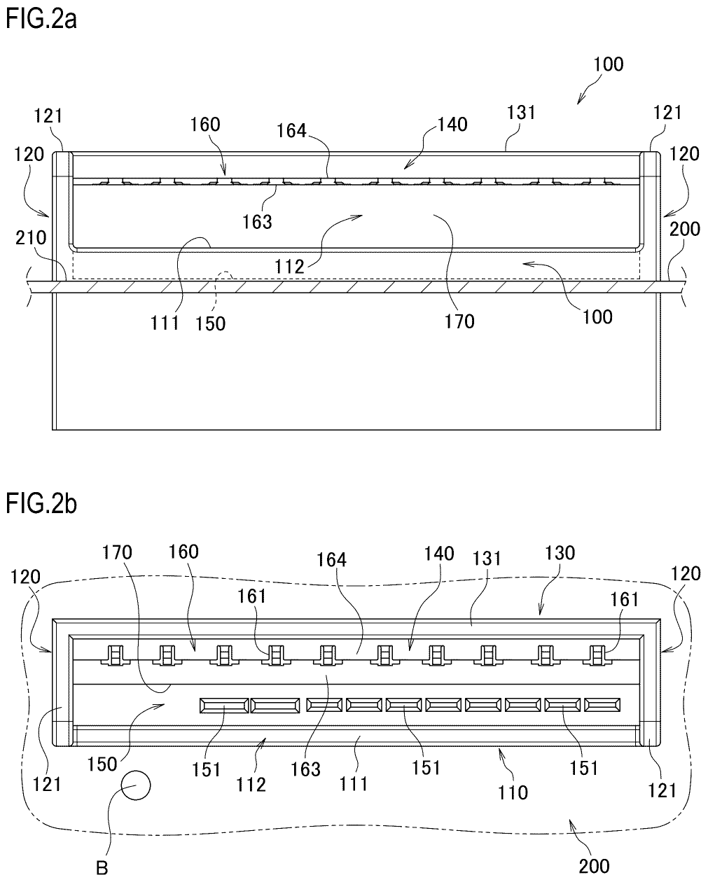

First, a fuse box 100 of the present invention is illustrated in FIGS. 1A to 2B. FIG. 1A is an overall perspective view of a fuse box 100, FIG. 1B is an overall perspective view of a state in which the fuse box 100 is mounted on a power distribution box 200, FIG. 2A is a front view of a state in which the fuse box 100 is mounted on the power distribution box 200, and FIG. 2B is a plan view of a state in which the fuse box 100 is mounted on the power distribution box 200.

The fuse box 100 has a box shape and is made of synthetic resin as a whole, and includes a front wall 110, a side wall 120, and a rear wall 130. As illustrated in FIG. 1B, the fuse box 100 is mounted on, for example, the power distribution box 200 loaded on an automobile, and is integrally formed with the power distribution box 200, or is mounted on an automobile body by mounting a cover that covers an opening portion to the fuse box 100. The interior of the fuse box 100 is a housing space 140 capable of housing a fuse 900 to be described later, and the housing space 140 is surrounded by a front wall 110, side walls 120, and a rear wall 130 and has an open upper side. An upper end 111 of the front wall 110 extends so as to connect the side walls 120 on both sides, and is lower than upper ends 121 of the side walls 120 and an upper end 131 of the rear wall 130. An upper portion of the upper end 111 of the front wall 110 is an opening portion 112 opening forward.

In the housing space 140, a first connection portion 150 that supports an external terminal side of the fuse 900 to be described later and a second connection portion 160 that supports an external fuse side of the fuse 900 are provided. The second connection portion 160 is located above the first connection portion 150, and the second connection portion 160 and the first connection portion 150 are connected by a wall portion 170 rising upward from the first connection portion 150. The wall portion 170 is a flat side surface, and rises perpendicularly to the first connection portion 150. The opening portion 112 is disposed in front of the connection portions (first connection portion 150 and second connection portion 160). The wall portion 170 rises perpendicularly to the first connection portion 150, but is not limited thereto, and may have any configuration such as rising obliquely as long as it rises upward from the first connection portion 150.

The first connection portion 150 has a flat surface, and is provided with a plurality of connection holes 151 into which external terminals 920 of the fuse 900 are inserted. Further, a space 152 is formed on a back surface side of the first connection portion 150, and as will be described later, a first connection terminal connected to the external terminal 920 of the fuse 900 can be inserted from below.

The second connection portion 160 is provided with a plurality of connection holes 161 through which a second connection terminal connected to a connection terminal 720 of an external fuse 700 of the fuse 900 can be inserted. Further, a space 162 is formed on a back surface side of the second connection portion 160, and a second connection terminal connected to the connection terminal 720 of the external fuse 700 can be inserted from below. Moreover, the second connection portion 160 includes a front flat lower step portion 163 and a rear flat upper step portion 164, the upper step portion 164 is disposed at a position higher than the lower step portion 163, and the second connection portion 160 is formed in a stepped shape by the lower step portion 163 and the upper step portion 164.

As illustrated in FIG. 1B, in a state where the fuse box 100 is mounted on the power distribution box 200, about the lower half of the fuse box 100 is in a state of being embedded below an upper surface 210 of the power distribution box 200. Further, the upper end 111 of the front wall 110 of the fuse box 100 protrudes upward from the upper surface 210 of the power distribution box 200, and the upper end 121 of the side wall 120 and the upper end 131 of the rear wall 130 protrude further upward than the upper end 111 of the front wall 110.

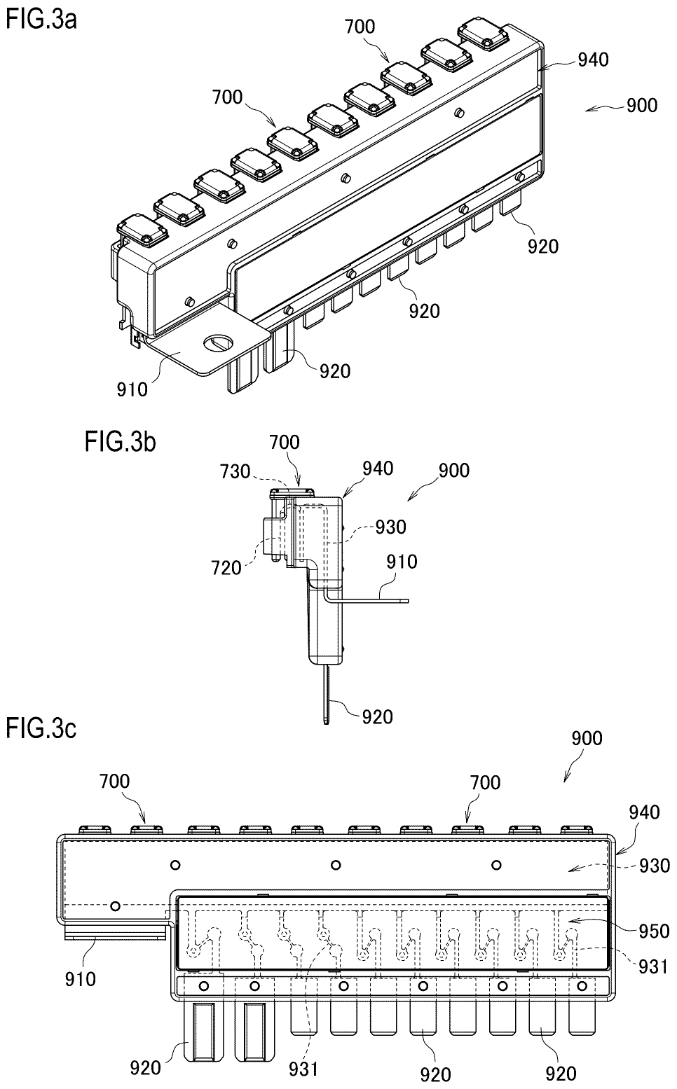

FIG. 3 shows the fuse 900 that can be mounted on the fuse box 100 of the present invention. Further, FIG. 3A is a perspective view of the fuse 900, FIG. 3B is a side view of the fuse 900, and FIG. 3C is a front view of the fuse 900.

As shown in FIGS. 3A to 3C, the fuse 900 is a conventionally used fuse as shown in Japanese Patent No. 7412035, and includes an input terminal 910, an external terminal 920, a bus bar 930 provided between the input terminal 910 and the external terminal 920, and a housing 940 covering the bus bar 930. A fused portion 931 is provided in a part of the bus bar 930, and when an overcurrent flows from a power source side such as a battery connected to the input terminal 910, the fused portion 931 is fused, so that loads of various electrical components connected to the external terminal 920 can be protected. Further, it is possible to confirm whether or not the fused portion 931 inside is fused from a visibility window 950 provided in a part of the housing 940. The bus bar 930 is configured to be mountable on the external fuse 700 including a fused portion 730 and a connection terminal 720. When an overcurrent flows from a power source side such as a battery connected to the input terminal 910, the fused portion 730 of the external fuse 700 is fused, so that loads of various electrical components connected to the connection terminal 720 can be protected.

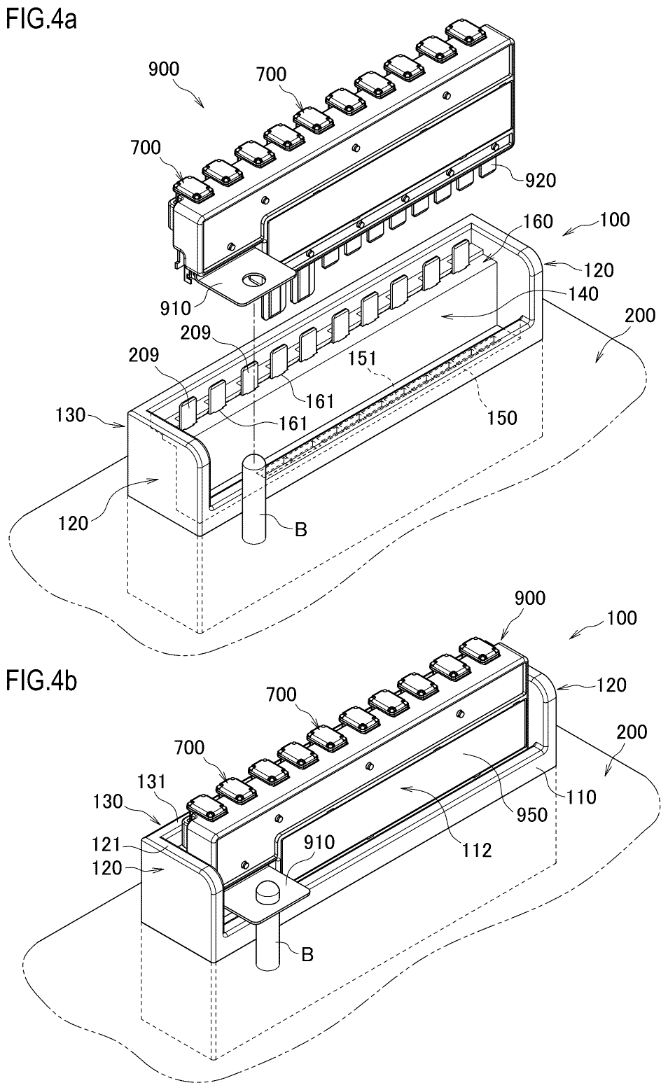

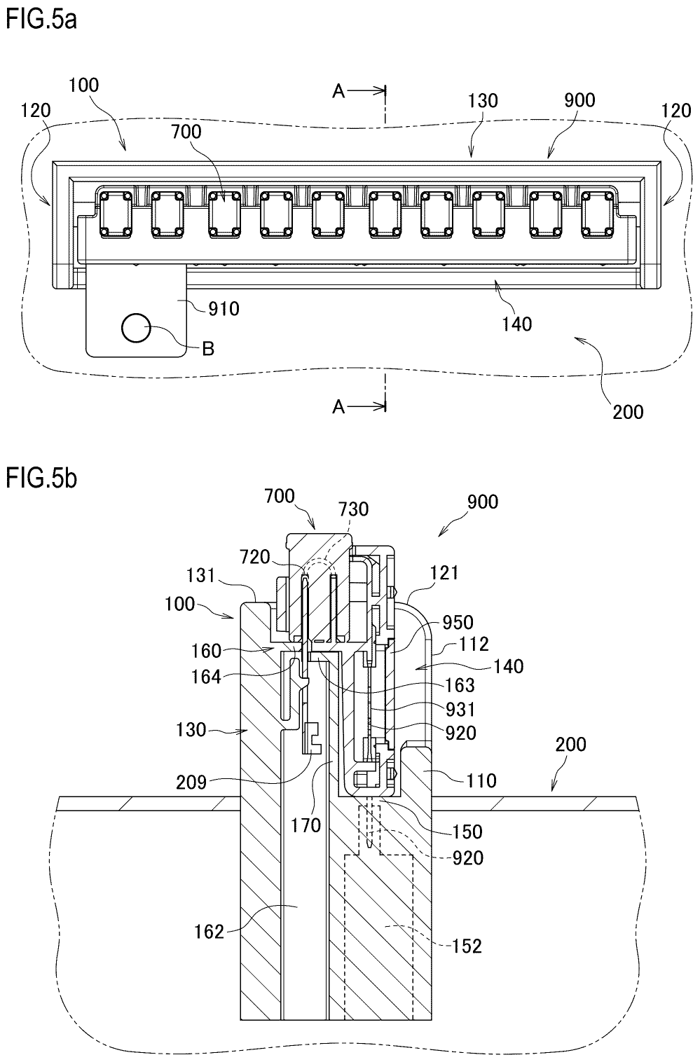

FIGS. 4A to 5B illustrate a state in which the fuse 900 is mounted on the fuse box 100. FIG. 4A is a perspective view of a state before the fuse 900 is inserted into the fuse box 100, FIG. 4B is a perspective view of a state where the fuse 900 is mounted on the fuse box 100, FIG. 5A is a plan view of a state where the fuse 900 is mounted on the fuse box 100, and FIG. 5B is a cross-sectional view taken along line A-A.

As shown in FIG. 4, the fuse 900 is housed in the housing space 140 of the fuse box 100 from above the fuse box 100 such that the external terminal 920 extending downward from the fuse 900 is inserted into the connection hole 151 of the first connection portion 150 of the fuse box 100. The second connection terminal 209 is inserted into the connection hole 161 of second connection portion 160 from below, and the second connection terminal 209 protrudes upward from second connection portion 160. Therefore, when the fuse 900 is housed in the fuse box 100, as shown in FIG. 5B, the second connection terminal 209 is inserted into and connected to the connection terminal 720 of the external fuse 700 of the fuse 900.

As illustrated in FIGS. 4B, 5A and 5B, in a state where the fuse 900 is housed in the fuse box 100, a battery post B is connected to the input terminal 910 of the fuse 900. When the fuse 900 is housed in the fuse box 100, the rear wall 130 and the side wall 120 of the fuse box 100 guide the fuse 900 so as to surround the periphery of the fuse 900, so that the fuse 900 is easily mounted on the fuse box 100. Further, since the opening portion 112 is disposed on the front side of the connection portion (first connection portion 150 or second connection portion 160) for connecting the fuse 900 to another connection terminal (first connection terminal or second connection terminal), it is possible to visually confirm the insertion state of the fuse 900 (for example, whether the fuse 900 is firmly inserted deep). Further, as illustrated in FIG. 4B, since the visibility window 950 of the fuse 900 is exposed by the opening portion 112, it is possible to check whether or not the internal fused portion 931 is fused.

Although the upper side of the front wall 110 is the opening portion 112, since the front wall 110 protrudes upward from the first connection portion 150, the front wall 110 surrounds a lower side of the external terminal 920 of the fuse 900 in a state where the fuse 900 is mounted on the fuse box 100. Therefore, the front wall 110 can guide the external terminal 920 side of the fuse 900 when the fuse 900 is mounted on the fuse box 100. Although the first connection portion 150 and the second connection portion 160 are provided as connection portions to which the fuse 900 is connected, the present invention is not limited thereto, and one connection portion or three or more connection portions may be provided according to the configuration of the fuse 900. Although the external terminal 920 side of the fuse 900 is connected to the first connection portion 150 and the external fuse 700 side of the fuse 900 is connected to the second connection portion 160, the present invention is not limited thereto, and the first connection portion 150 and the second connection portion 160 may be connected to random portions of the fuse 900.

Further, the first connection portion 150 on the lower side of the fuse box 100 supports the external terminal 920 side of the downward extending fuse 900, and the second connection portion 160 on the upper side of the fuse box 100 supports the external fuse 700 side positioned above the external terminal 920 of the fuse 900. The wall portion 170 of the fuse box 100 is disposed along the fused portion 931 of the downward extending fuse 900 and the external terminal 920. Therefore, the first connection portion 150, the wall portion 170, and the second connection portion 160 of the fuse box 100 are formed in a continuous step shape, and the inverted L-shaped fuse 900 can be stably mounted. Since the upper step portion 164 of the second connection portion 160 is located slightly above the lower step portion 163, the upper step portion 164 can directly support a bottom surface side of the external fuse 700 of the fuse 900.

In a state where the fuse 900 is mounted on the fuse box 100, a part of the external fuse 700 of the fuse 900 is positioned above the upper end 121 of the side wall 120 and the upper end 131 of the rear wall 130 of the fuse box 100. Therefore, even when the fuse 900 is mounted on the fuse box 100, the external fuse 700 of the fuse 900 can be easily replaced.

As a mode of use of the fuse 900, a first connection terminal (not shown) is attached to the external terminal 920 from below in a state where the fuse 900 is mounted on the fuse box 100. The first connection terminal is electrically connected to a load such as various external electrical components. For example, when an overcurrent flows from the power source side such as a battery connected to the input terminal 910, the fused portion 931 is fused, so that loads of various electrical components connected to the external terminal 920 can be protected. The second connection terminal 209 connected to the connection terminal 720 of the external fuse 700 is electrically connected to loads such as various external electrical components via a connection line (not shown). For example, when an overcurrent flows from the power source side such as a battery connected to the input terminal 910, the fused portion 730 of the external fuse 700 is fused, so that loads of various electrical components connected to the second connection terminal 209 can be protected.

The fuse box of the present invention is not limited to the above embodiment, and various modifications and combinations are allowable within the scope of the accompanying claims and the scope of the embodiment, and these modifications and combinations are also encompassed in the scope of protection.

1. A fuse box for mounting a fuse, the fuse box comprising:
a connection portion connected to the fuse; and
a side wall and a rear wall surrounding the connection portion
wherein an opening portion is disposed in front of the connection portion.

2. The fuse box according to claim 1, wherein
the connection portion includes a first connection portion and a second connection portion, and
the second connection portion is disposed at a position higher than the first connection portion, and is coupled to the first connection portion by a wall portion rising upward from the first connection portion.
